(19) United States
(12) Patent Application Publication
(10) Pub. No.: US 2009/0089498 A1
(43) Pub. Date: Apr. 2, 2009

(54) Transparently migrating ongoing I/O to virtualized storage

(76) Inventor: Michael Cameron Hay, Mountain View, CA (US)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/906,701

(22) Filed: Oct. 2, 2007

(51) Int. Cl. G06F 12/00

(52) U.S. Cl. 711/112; 711/E12.001

(57) ABSTRACT

A method, medium and apparatus for transparently virtualizing storage in an operating computer system. The method includes a computer's recognizing a storage device connected to the computer through a physical connection, a storage virtualizing device's virtualizing the storage device, the computer's relating the storage device and the virtualized storage device and, finally, the computer's failing over to the virtualized storage device on the computer. While virtualizing, the storage virtualizing device, the physical connection and the first recognition maybe maintained through the step of virtualizing. While virtualizing, the method may recognize the storage device through a physical connection, virtualize the storage device and expose the virtualized storage device. In an further form of the method, from the time of recognition through the time of failing over, no I/O is interrupted by the method.

### TECHNICAL FIELD

This invention generally relates to computer data processing systems and data storage and, more particularly, to virtualization and migrating I/O.

### BACKGROUND ART

FIG. 1 illustrates the well-known architecture of a computer system 1. The computer system includes a computer (host) 11, a storage subsystem 12 and a communications subsystem 13. The communications subsystem 13 communicatively couples the computer 11 and the storage subsystem 12. The communications subsystem 13 may be, for example, Ethernet or Fiber Channel.

The computer 11 includes a CPU 111, a memory 112, the I/O devices (not shown) and a bus 114. The bus 114 communicatively couples the other computer components. The memory 112 includes application software 1121.

The application software 1121 initiates I/O with the storage subsystem 12.

Imagine that the administrator of the system 1 purchases a storage device 14 that virtualizes at the controller level. He wishes to migrate the I/O target of the host 11 and its applications 1121 from the storage subsystem 12 to the virtualizing storage device 14.

The conventional method begins by gracefully suspending or shutting down the applications 1121. The administrator then disconnects the storage subsystem 12 from the host 11, connects the storage subsystem 12 to the virtualizing storage device 14, configures the virtualizing storage device 14 to present storage, connects the virtualizing storage device 14 to the host 11 and then restarts or resumes the applications 1121.

This method affects system availability. It requires suspending or shutting down the raison d'etre of the system 1: the applications 1121. Where percent system availability is an important metric, this method negatively impacts the system's performance. Where system availability is critical, this virtualization route is clearly inadequate.

Accordingly, a need exists for a way to virtualize existing storage behind a new storage device—without risking a system outage of any kind.

These and other goals of the invention will be readily apparent to one of skill in the art on reading the background above and the description below.

### BRIEF SUMMARY OF THE INVENTION

Herein are taught a method, medium and apparatus for transparently virtualizing storage in an operating computer system. The method includes a computer's recognizing a storage device connected to the computer through a physical connection, a storage virtualizing device's virtualizing the storage device, the computer's relating the storage device and the virtualized storage device and, finally, the computer's failing over to the virtualized storage device on the computer. In one embodiment, the step of virtualizing comprises maintaining the physical connection and the first recognition through the step of virtualizing. In another embodiment, the step of virtualizing comprises recognizing the storage device through a physical connection, virtualizing the storage device and exposing the virtualized storage device. In yet another embodiment of the method, from the time of recognition through the time of failing over, no I/O is interrupted by the method.

The various features of the present invention and its preferred embodiments may be better understood by referring to the following discussion and the accompanying drawings in which like reference numerals refer to like elements in the several figures. The contents of the following discussion and the drawings are set forth as examples only and should not be understood to represent limitations upon the scope of the present invention.

### BRIEF DESCRIPTION OF THE DRAWINGS

FIG. 1 illustrates the well-known architecture of a computer system.

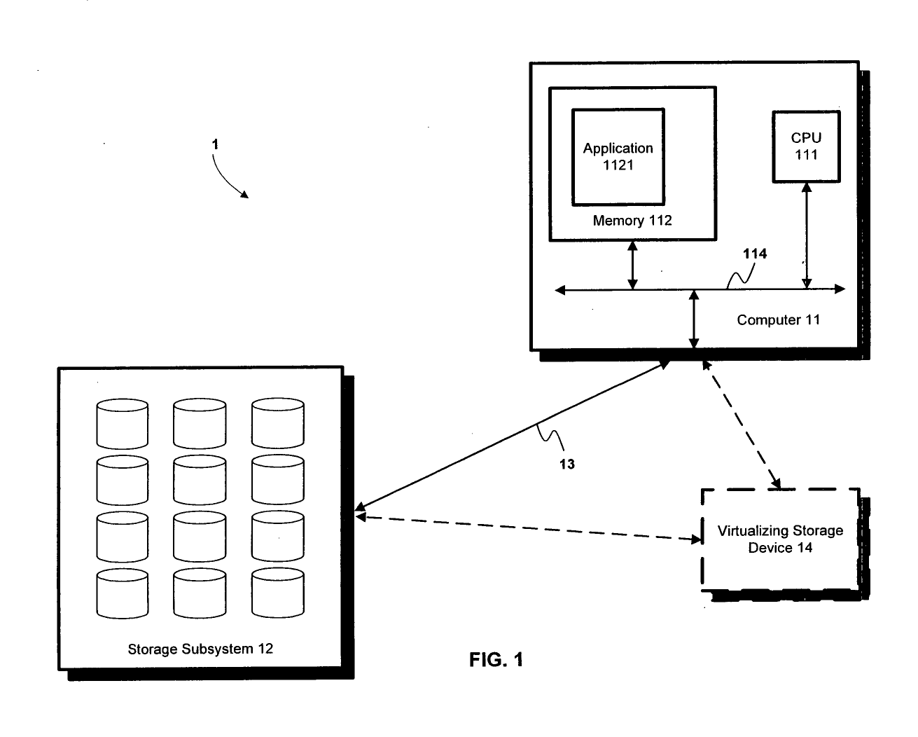

FIG. 2 illustrates a computer system according to an embodiment of the invention.

FIG. 3 illustrates the computer system of FIG. 2 in operation

FIG. 4 illustrates a method of virtualizing existing storage behind a virtualizing storage device, according to one embodiment of the invention.

FIG. 5 illustrates the result of the transparent migration, according to one embodiment of the invention.

### DETAILED DESCRIPTION OF THE INVENTION

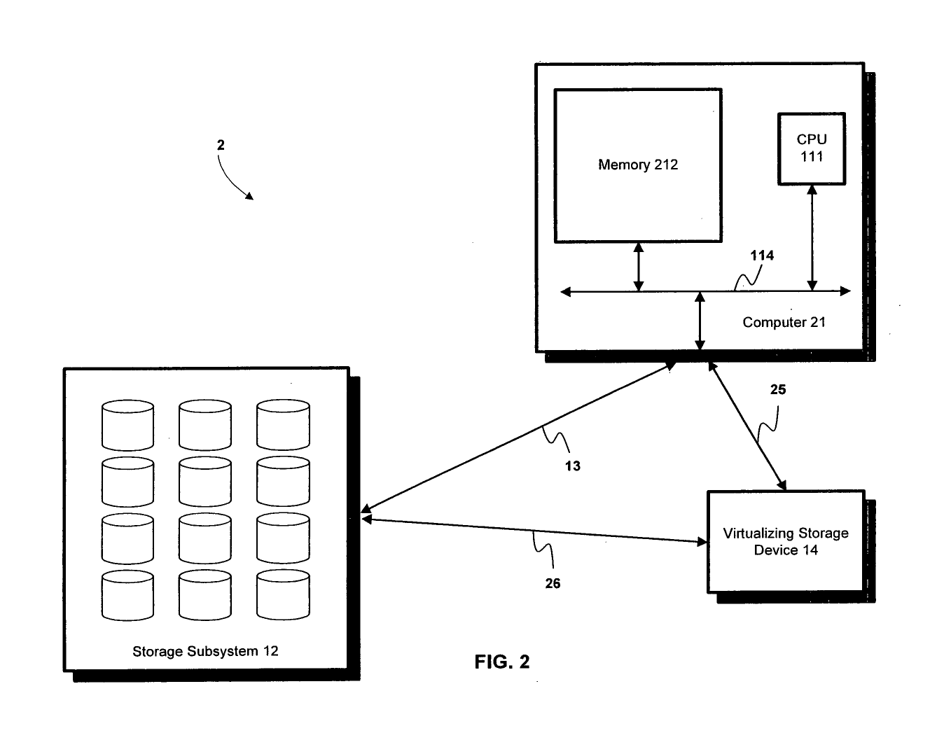

FIG. 2 illustrates a computer system 2 according to an embodiment of the invention. The computer system 2 includes a computer (host) 21, the storage subsystem 12 and the storage virtualizer 14, as well as first, second and third communications subsystem 13, 25, 26. The first communications subsystem 13 communicatively couples the computer 21 and the storage subsystem 12. The second communications subsystem 25 communicatively couples the computer 11 and the storage virtualizer 14, and the third communications subsystem communicatively couples the storage subsystem 12 and the storage virtualizer 24. Two or all of the communications subsystems may integrated into one communications subsystem.

The computer 21 includes a CPU 111, memory 212, I/O devices (not shown) and a bus 114. The bus 114 communicatively couples the other computer components.

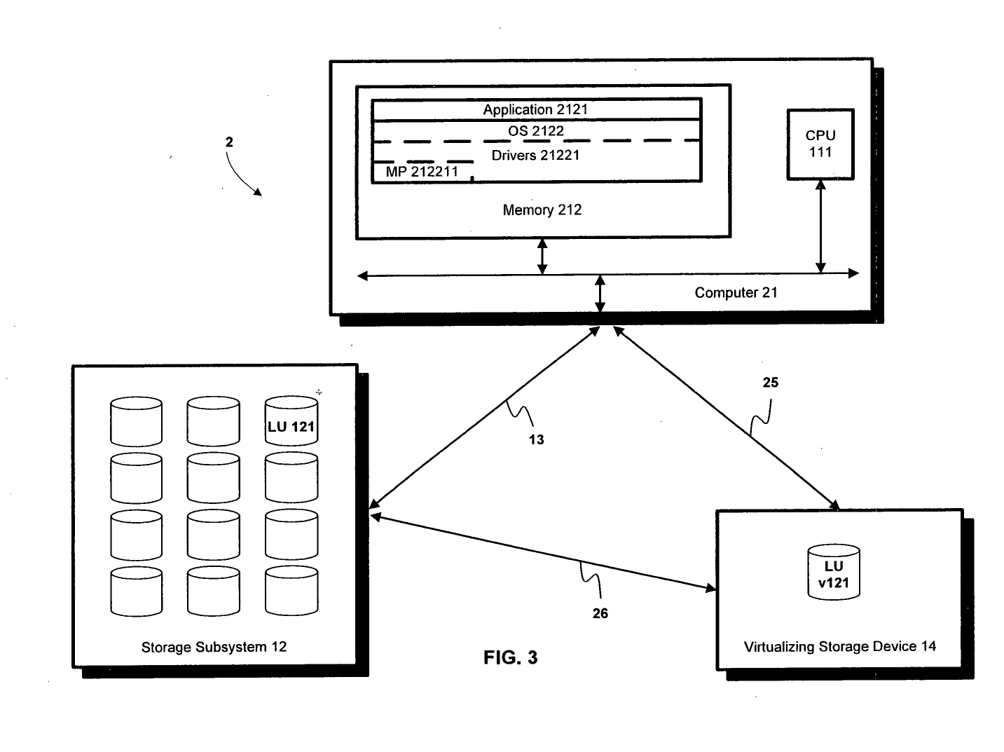

FIG. 3 illustrates the computer system 21 in operation. The memory 212 includes application software 2121, operating-system software 2122 and driver software 21221. The memory 212 also includes multipath software 212211.

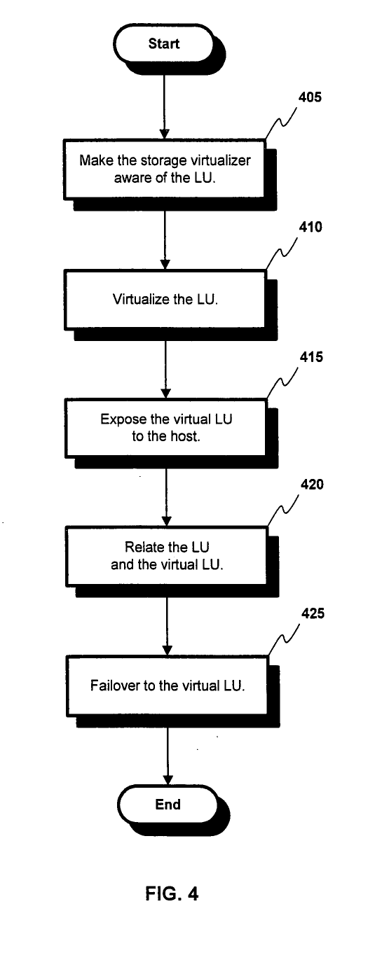

Now again suppose that the administrator of the system 2 wants to virtualize the logical unit (LU) 121 behind the storage device 14. FIG. 4 illustrates a method of virtualizing existing storage behind a virtualizing storage device, according to one embodiment of the invention. The administrator makes the storage virtualizer 14 aware of the LU 121, step 405; the administrator physically connects the storage device 12 to the virtualizer 14. The connection 26 exposes to the virtualizer 14 the storage device 12 and such logical units as the storage device 12 advertises. With its awareness of the LU 121, the storage virtualizer 14, on command, virtualizes the LU 121 into the virtual logical unit v121, step 410.

The administrator then establishes a path 25 from the host 21 to the virtualizer 14. The establishment of the connection 25 exposes the virtual LU v121 to the host 21, step 415. The host 21 and its lower-level software (including the multipathing software 212211) thus become aware of the virtual LU v121.

In this configuration, the host 21 and its applications 111 see two LUs 121 and v121, accessible by independent paths 13, 25. (The host 21 is typically unaware of the virtual nature of the virtual LU v121.)

The administrator directs the multipathing software 212211 to relate the LU 121 and the LU v121, step 420. This relationship creates a second path to the LU 121 through its virtual version v121. The host 21 and its applications 2121 now see one LUN 121, while the multipathing software 212211 maintains its knowledge of the multiple paths to the multiple LUs 121, v121.

The administrator then directs the multipathing software 212211 to fail over the LU 121 path 13 to the path 25 to the virtual LU v121, step 425. The remaining path 25 handles the traffic between the applications 2121 and the LU 121 so that the applications 2121 experience no impact from the failing over.

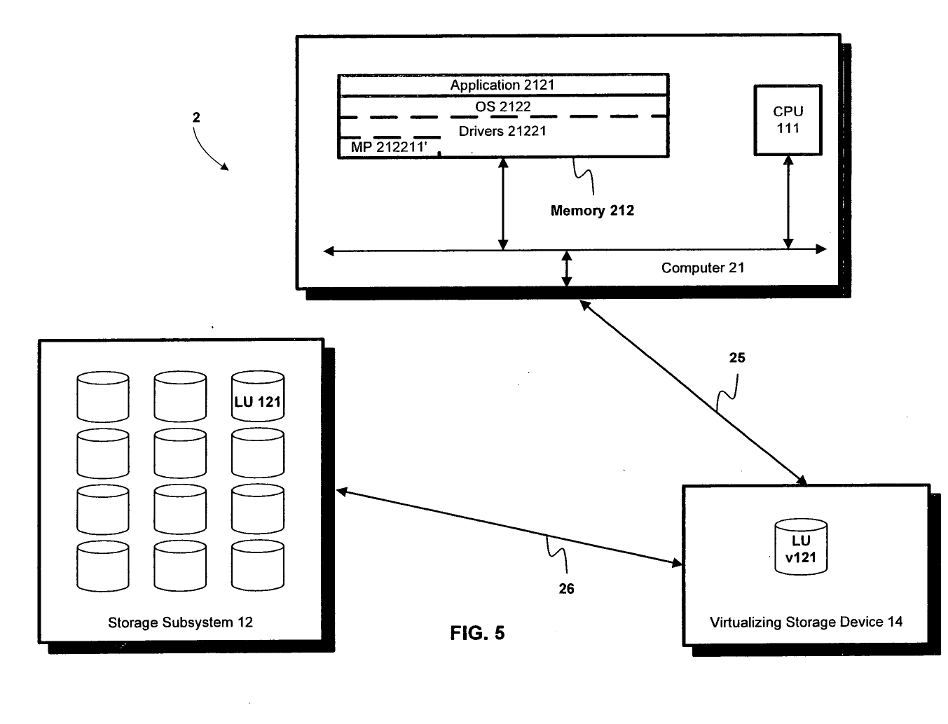

The result is the transparent migration of existing operational storage to a virtualized storage environment. FIG. 5 illustrates the result according to one embodiment of the invention.

Of course, the number of LUs 121 to be migrated can be more than one, and the migrations can occur substantially simultaneously. The number of physical paths to the LU 121 can be more than one, and multiple paths can fail over substantially simultaneously.

Also, variations on the migration method are obvious to one of skill in the art. For example, the sequence of some steps can be varied without affecting the result of the method.

This specification incorporates by reference all publications and patent applications mentioned herein, to the same extent if the specification had specifically and individually incorporated by reference each such individual publication or patent application.

As this invention may be embodied in several forms without departing from the spirit of essential characteristics thereof, the present embodiment is therefore illustrative and not restrictive. Changes that fall within the metes and bounds of the claims, or the equivalence of such metes and bounds thereof are therefore intended to be embraced by the claims.

1. A method for virtualizing storage in a computer system, the method comprising:
a computer's recognizing a storage device connected to the computer through a physical connection;
a storage virtualizing device's virtualizing the storage device;
the computer's relating the storage device and the virtualized storage device; and
the computer's failing over to the virtualized storage device on the computer.

2. The method of claim 1 wherein the step of virtualizing comprises maintaining the physical connection and the first recognition through the step of virtualizing.

3. The method of claim 1 wherein the step of virtualizing comprises
recognizing the storage device through a physical connection;
virtualizing the storage device; and
exposing the virtualized storage device.

4. The method of claim 1 wherein from the time of recognition through the time of failing over, no I/O is interrupted by the method.
